(19) United States
(12) Patent Application Publication
(10) Pub. No.: US 2014/0189047 A1
(43) Pub. Date: Jul. 3, 2014

(54) EXPANDING CONTENT INVENTORY

(71) Applicant: Google Inc., (US)

(72) Inventors: Reto Strobl, Walenstadt (CH); Tamas Foldenyi, Zurich (CH)

(73) Assignee: Google Inc., Mountain View, CA (US)

(21) Appl. No.: 13/731,231

(22) Filed: Dec. 31, 2012

(51) Int. Cl. H04L 29/08

(52) U.S. Cl. CPC H04L 67/32
USPC 709/217

(57) ABSTRACT

Methods, systems, and apparatus, including computer programs encoded on a computer storage medium, for serving advertisements. In one aspect, a method includes receiving, from a user device, a request for a content item for presentation with a first resource. The first resource is associated with a first content category. A first set of content items that are eligible for presentation with resources associated with the first content category are identified. A determination is made that the user device navigated to the first resource from a second resource. The second resource is associated with a second content category, different than the first content category. A second set of content items that are eligible for presentation with resources associated with the second content category are identified. A content item is selected from among the first and second set of content items. The selected content item is provided to the user device.

### BACKGROUND

This specification relates to processing content requests.

Networked resources provide a popular medium for serving content items, such as advertisements or other content items (e.g., audio files, video files, and/or images). For example, many web pages include content item slots, such as advertising slots, for displaying content items. The web pages typically include, for each content item slot, embedded instructions that are configured to request a content item from a content item provider, such as an advertisement provider. Some content item providers may select content items to provide based on the contents of the web page, for example using data about the web page that is included in the request.

### SUMMARY

In general, one innovative aspect of the subject matter described in this specification can be embodied in methods that include the actions of receiving, from a user device, a request for a content item for presentation with a first resource, the first resource being associated with one or more content categories including a first content category; identifying a first set of content items that are eligible for presentation with resources associated with the first content category; determining that the user device navigated, directly or indirectly, to the first resource from a second resource, the second resource being associated with one or more content categories including a second content category, the second content category being different than the first content category; identifying, in response to determining that the user device navigated to the first resource from the second resource, a second set of content items that are eligible for presentation with resources associated with the second content category, the second set of content items including a disjoint set relative to the first set of content items; selecting, from among the first set of content items and the second set of content items, a content item for presentation with the first resource; and providing, to the user device, the selected content item for presentation with the first resource. Other embodiments of this aspect include corresponding systems, apparatus, and computer programs, configured to perform the actions of the methods, encoded on computer storage devices.

These and other embodiments can each optionally include one or more of the following features. Selecting a content item for presentation with the first resource can include selecting a content item from the second set of content items.

Selecting the content item from the second set of content items can include determining that a particular content item in the second set of content items has a highest rank score of content items that are included in the first set of content items and the second set of content items and selecting the particular content item from the second set of content items. The rank score for each content item can be based on at least one of a bid amount for the content item and a performance measure for the content item.

The second resource can be a last resource that was presented on the user device prior to presentation of the first resource. The selected advertisement can be selected irrespective of the first content category.

Aspects can further include determining that a particular content item in the second set of content items is not eligible for inclusion in the first set of content items. Selecting a content item can include selecting the particular content item for presentation with the first resource. The first resource can be one of a web page, a video, a game, an image, or a map.

Particular embodiments of the subject matter described in this specification can be implemented so as to realize one or more of the following advantages. The inventory of content items eligible for presentation with a particular resource is increased or expanded by including, as eligible content items, content items that are relevant to a previously presented resource. The number of available advertising slots for advertisers is increased as advertisements for the advertiser can be presented with resources that are presented after presentation of a resource for which the content item is eligible. The advertiser's cost for serving advertisements can be reduced when the advertisements are presented with resources that are associated with (e.g., belong to, included in, or stored with a reference to) content categories for which the advertisement costs are less than the advertisement costs for a content category of the advertisements. The amount of revenue realized by publishers of resources that are associated with obscure or less common content categories can be increased when advertisements relevant to more common content categories are presented with the resource, as the bid prices for these advertisements may be higher than the bid prices for advertisements relevant to the less common content categories.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which an advertisement management system provides advertisements.

FIG. 2 is a flow diagram of an example process for providing an advertisement in response to an advertisement request.

FIG. 3 is a block diagram illustrating a sequence of resources presented at a user device and advertisements eligible for presentation of the resources.

Like reference numbers and designations in the various drawings indicate like elements.

### DETAILED DESCRIPTION

A content distribution system, such as an advertisement management system, can provide content items (e.g., advertisements) in response to requests received from devices. When a request is received, the content distribution system can identify content items that are relevant to a resource with which the content item is to be presented. For example, a web page directed to gardening may initiate a request to the content distribution system for an advertisement to display on the web page. In response to the request, the content distribution system may identify advertisements relevant to gardening (e.g., ads for flowers, gardening tools, or garden centers) and provide the identified advertisements to the device for presentation on the web page.

Resources that are associated with (e.g., belong to, are included in, or stored with a reference to) certain content categories may have a more limited selection of available content items than resources that are associated with other content categories. For example, an advertisement management system may have fewer advertisements relevant to flowers than it does advertisements relevant to computers or automobiles. To increase the number of available advertisements for a particular resource, the advertisement management system may include, as eligible content items for the resource, content items that are relevant to the content of a resource that was previously presented on the device. For example, a group of eligible advertisements for a particular resource may include advertisements that are relevant to the particular resource and advertisements that are relevant to a previously presented resource. The advertisement management system can select one or more advertisements from the group to provide for display on the particular resource.

To illustrate, a user may navigate from a car review web page to a web page directed to obscure collectables. The group of eligible advertisements for the obscure collectables web page may include advertisements that are relevant to obscure collectables and also include advertisements that are relevant to cars. As there may be fewer advertisements available that are eligible to be presented with resources for the obscure collectables, the advertisement management system may select an advertisement relevant to a car since the car review web page was previously presented at the user device. As the user has recently visited a web page with content related to cars, an advertisement for a car may still be of interest to the user while the user is viewing the collectables web page.

Expanding the inventory of content items to include content items relevant to a previously presented resource can be beneficial to the publisher of the resource and to the content item provider. To illustrate, publishers of resources that are associated with a content category for which fewer content items are available may benefit from an increased number of content items that can be presented in content item slots on their resources. The additional content items may also have higher bid prices, resulting in additional revenue for the publisher.

Advertisers that are seeking additional advertisement display opportunities can opt in to having their advertisements presented on resources that are not relevant to their products, for example, when a user device to which the resource will be presented is a user device at which a previously presented resource included content that is relevant to their products, or associated with a content category for which the advertisements are eligible. If the demand for presenting the advertisements on resources that include content relevant to the advertisements is relatively high, the advertiser may spend less to present the advertisements on the next resource visited by the user.

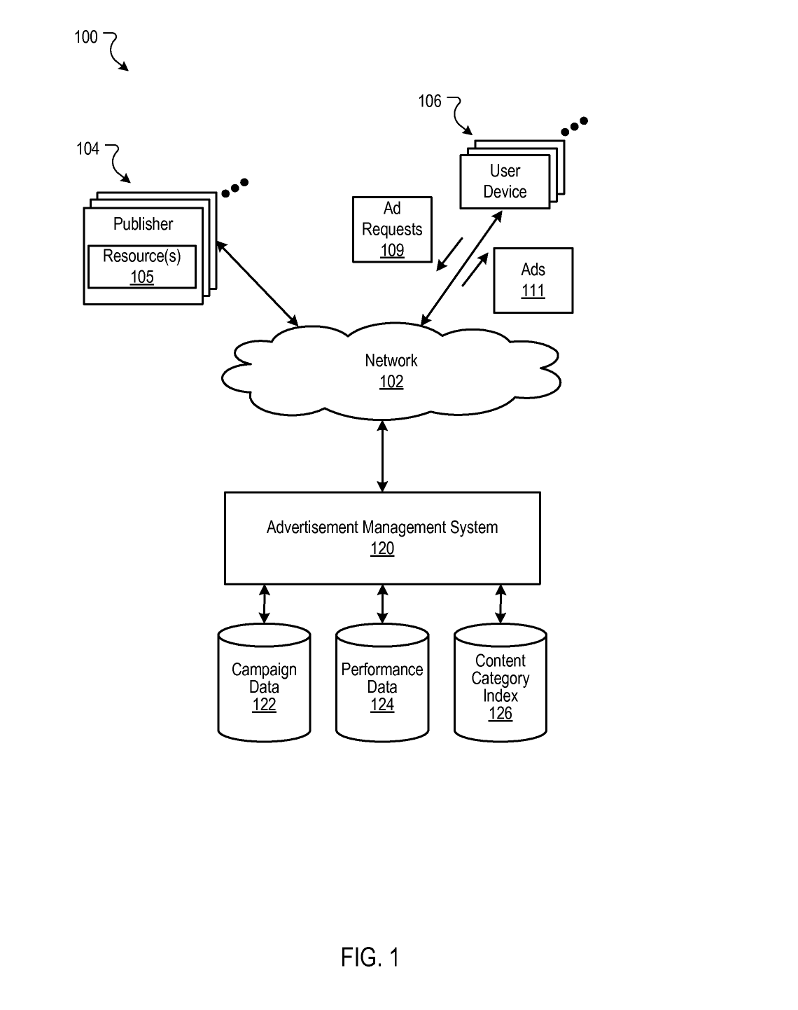

FIG. 1 is a block diagram of an example environment 100 in which an advertisement management system 120 provides advertisements. A computer network 102, such as a local area network (LAN), wide area network (WAN), the Internet, or a combination thereof, connects publisher web sites 104, user devices 106, and an advertisement management system 120. The online environment 100 may include many publisher web sites 104 and user devices 106.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a content publisher, which is an entity that controls, manages and/or owns the website 104.

A resource is any data that can be provided by the publisher 104 over the network 102 and that is associated with a resource address. Resources include HTML pages, word processing documents, and portable document format (PDF) documents, images, videos, online games, maps, and feed sources, to name just a few. The resources can include content, such as words, phrases, pictures, and so on, and may include embedded information (such as meta information and hyperlinks) and/or embedded instructions (such as scripts).

A user device 106 is an electronic device that is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website on the world wide web or a local area network.

The advertisement management system 120 facilitates the provisioning of advertisements with the resources 105. In particular, the advertisement management system 120 allows advertisers to define rules that take into account attributes of the particular resource on which the advertisements are to be presented. Example rules include keyword-based rules, in which advertisers provide bids for keywords, and these bids are used to select an advertiser that will provide an advertisement for presentation at a user device. For example, when a particular keyword is matched by a search query submitted from a user device or webpage content requested from the user device, the advertisements that are associated with the particular keyword are selected as eligible advertisements to be provided to the user device. In turn, the bids for each of the eligible advertisements can be used to determine which advertisement will be presented.

The advertisement management system 120 includes, or is communicably coupled to, a data storage system that stores campaign data 122, performance data 124, and a content category index 126. The campaign data 122 stores advertisements, targeting information, and budgeting information for advertisers. The performance data 124 stores data indicating the performance of the advertisements that are served. Such performance data can include, for example, click through rates for advertisements, the number of impressions for advertisements, and the number of conversions for advertisements. Other performance data can also be stored.

The campaign data 122 and the performance data 124 are used as input parameters to an advertisement auction. For example, the advertisement management system 120, in response to each request for advertisements, conducts an auction to select advertisements that are provided in response to the request. The advertisements are ranked according to a rank score that, in some implementations, is proportional to a value based on an advertisement bid and one or more parameters specified in the performance data 124. The highest ranked advertisements resulting from the auction are selected and provided to the requesting user device.

The advertisement management system 120 allows advertisers to define rules that specify categories of resources with which the advertisers' advertisements are eligible to be presented. In some implementations, the advertisers can specify the categories of resources through selection of one or more content categories of resources. A content category is a set of resources that have been identified as being relevant to a same topic. For example, a resource including content about football and a resource including content about soccer may both be members of the content category titled sports.

Advertisers can define rules specifying that their advertisements are eligible for presentation with resources that are associated with content categories that the advertisers' deem relevant to the advertisements. For example, a hotel chain may specify that its advertisements are eligible to be presented on resources are associated with a travel content category and on resources that are associated with a hotel content category, as the topics travel and hotel are generally relevant to a hotel advertisement.

The advertisement management system 120 may also allow advertisers to define rules that specify content categories on which the advertiser's advertisements are not to be presented. For example, the hotel chain may elect to not have its advertisements presented on resources that associated with a gardening content category.

The content category index 126 includes an index of content categories for which resources 105 can be included as members. In some implementations, the content categories include high level content categories and subcategories for some or all of the high level content categories. For example, a sports content category may have subcategories of baseball and football. A resource that is associated with a subcategory may also be associated with the corresponding higher level content category. For example, a resource 105 that has content related to football may be associated with the football content category and the sports content category. Although two levels are illustrated in this example, the content categories can include other numbers of levels in a hierarchical structure. For example, the football content category may be associated with a team sports content category, which is associated with to a sports content category.

In some implementations, the content category index 126 includes data that maps particular resources 105 to their corresponding content categories. For example, the index may include a list of known resources 105 and, for each resource, data specifying the content categories with which the resource 105 is associated. In some implementations, the content category index 126 includes, for each content category, criteria that can be used to assign a resource 105 to the content category. The advertisement management system 120 (or a user device 106) can use the criteria and data regarding a particular resource 105 to assign the resource 105 to one or more content categories, as described in more detail below.

In some implementations, each content category includes a set of keywords that can be used to determine whether a resource is associated with the content category. This determination can be made based on, for example, a comparison of terms included in the resource and the keywords of the content category. For example, if the resource includes one or more terms that match the keywords for the content category, the resource may be considered to be associated with the content category.

In some implementations, the determination of whether a resource is associated with a particular content category can be based on a topicality score for the resource. A topicality score is a value indicative of how relevant a resource is to a particular topic or category. The topicality score can be based, for example, on a number of references to the particular topic are included in the resource, a location in the resource (e.g., title, body, margin) of the reference to the particular topic, or presentation characteristics of the reference to the particular topic (e.g., bolded font). When the topicality score for the resource meets a threshold topicality score for the particular topic, the resource can be deemed relevant to the particular topic and/or included in a content category with other resources that have been deemed relevant to the particular topic.

The keywords for a content category can also be used to determine whether an advertisement is eligible to be presented with the resources that are associated with the content category. For example, an advertiser may specify keywords for its advertisement. If the keywords match the keywords for the content category, then the advertisement may be eligible for presentation with resources that are associated with the content category.

The advertisement management system 120 can also allow advertisers to opt into an inventory expansion feature that expands the content categories for which an advertiser's advertisements are eligible for presentation beyond those content categories selected by the advertiser. In general, an advertisement is considered eligible for presentation with resources that are associated with a particular content category if the advertiser specifies the particular content category for the advertisement or if the advertiser specifies keywords for the advertisement that match keywords for the content category. When the advertiser opts into the inventory expansion feature, the advertiser's advertisements become eligible for presentation with resources that are associated with additional content categories beyond those that the advertisement is eligible.

In some implementations, the inventory expansion feature makes the advertiser's advertisement an eligible advertisement for presentation on one or more resources that are presented at a user device following presentation, at the user device, of a resource that is associated with a content category that has been specified for the advertisement. That is, once a resource that is associated with one of the content categories for the advertisement has been requested by a user device, the advertisement will be an eligible advertisement for presentation with at least one subsequent resource that is requested by that user device. The advertisement will be eligible for presentation on the subsequent resource even if the subsequent resource is not associated with a content category that has been specified for the advertisement. Thus, the inventory expansion feature expands the resources with which the advertisement is eligible for presentation beyond the resources that are associated with the content categories that were selected for the advertisement.

Continuing the above example, if the hotel chain opts into the inventory expansion feature, advertisements for the hotel chain may be eligible to be provided with one or more resources that are requested by the user device following a request for a resource that is associated with the “travel” content category. For example, assume that the user device requests a resource that is associated with the “travel” content category, and then requests a resource that is associated with a “knitting” content category. In this example, the advertisement for the hotel chain will be eligible for presentation with the resource that is associated with the “knitting” category, even though the hotel chain did not select the “knitting” category for the advertisement.

The advertisement management system 120 can also allow publishers to opt in to the inventory expansion feature. From a publisher's perspective, the inventory expansion feature expands the inventory of advertisements that are eligible for presentation with a resource provided by the publisher. In particular, the inventory expansion feature expands the eligible advertisements for the resource to include advertisements that are not associated with a content category with which the resource is associated. For instance, in the example above, the inventory expansion feature expands the set of advertisements that are eligible for presentation with the “knitting” resource to include the advertisement for the hotel chain even assuming that the advertisement for the hotel chain would not have otherwise been eligible for presentation with the “knitting” resource.

In some implementations, when eligible advertisements are selected for a particular resource using the inventory expansion feature, the advertisement management system 120 considers only the resource that was presented immediately before the particular resource. For example, the inventory of eligible advertisements for the particular resource may include a first set of advertisements for which the content category for the particular resource has been specified as well as advertisements, not in the first set of advertisements, for which the specified content category is the content category of the resource that was presented immediately before the particular resource.

In some implementations, the advertisement management system 120 considers multiple previously presented resources for selecting eligible advertisements for the particular resource. For example, the inventory of eligible advertisements may include the advertisements that are included in the first set of advertisements from above, as well as advertisements, not in the first set of advertisements, for which content categories for at least one of up to two resources that were most recently presented on the user device 106 prior to the particular resource. In such implementations, the advertisement management system 120 may weight rank scores for the advertisements (e.g., rank scores determined using an auction process as described above) based on their corresponding resource's position within the sequence of presented resources. For example, the rank score for an advertisement eligible for the resource presented immediately before the particular resource may be weighted more than the rank score for an advertisement eligible for a resource that was presented two or three resources before the particular resource. The advertisement management system 120 can use the rank scores to select an advertisement to provide for the particular resource, as described above.

In some implementations, the advertisement management system 120 expands the inventory of eligible advertisements for a particular resource in response to a user device transitioning between content categories. A transition between content categories occurs when a user device 106 navigates, directly or indirectly, from a resource that is associated with a first content category to a resource that is associated with a second category that is different than the first category. For example, the user device 106 may navigate directly from the resource that is associated with the first content category to the resource that is associated with the second content category without navigating to an intermediate resource. The user device 106 may navigate indirectly from the resource that is associated with the first content category to the resource that is associated with the second content category by navigating from the resource that is associated with the first content category to an intermediate resource, and then navigates to the resource that is associated with the second category, for example.

A transition may occur at any level within the hierarchy of content category levels. For example, a transition may occur when a user device 106 navigates from a resource that is associated with a sports content category to a resource that is associated with a gardening content category. A transition may also occur when a user device 106 navigates from a resource that is associated with a soccer content category to a resource that is associated with a baseball content category, although both resources may be associated with a sports category. In this example, when a transition from a soccer category to a baseball category is detected, the advertisements eligible for the resource that is associated with the baseball content category may include a set of advertisements that are eligible for presentation with resources associated with the soccer content category, even if the set of advertisements would not otherwise have been eligible for presentation with the resource that is associated with the baseball content category.

In some implementations, a transition from one content category to another content category is only deemed to have occurred when the two content categories are not members of a same content category. For example, resources associated with a soccer content category and resources associated with a baseball content category may all be members of a larger sports content category. In this example, if a user device requests a resource that is associated with the soccer content category and then requests a resource that is associated with the baseball category, a transition between content categories may not be deemed to have occurred since the two resources are both associated with the sports content category. However, if the user device requests a resource that is associated with a gardening content category after requesting the resource that is associated with the soccer content category, a transition will be deemed to have occurred (assuming that these two content categories are not members of a same parent content category).

The advertisement management system 120 selects one or more advertisements from the eligible advertisements for the resource, and provides the advertisement(s) to the user device 106. When a user of a user device 106 selects an advertisement, the user device 106 generates a request for a landing page of the advertisement, which is typically a webpage of the advertiser. As used throughout this document the term landing page is a web page to which a user is redirected in response to user interaction with the advertisement. For example, if a user is redirected to a car dealer web page in response to clicking an advertisement for the car dealer, the car dealer web page is considered the landing page for the advertisement for the car dealer.

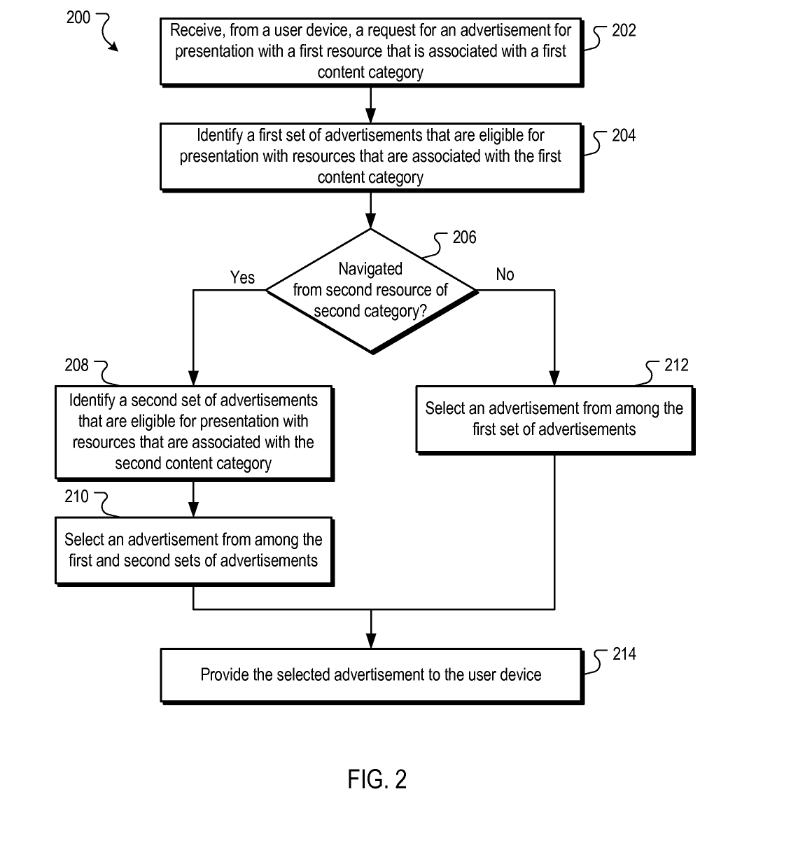

FIG. 2 is a flow diagram of an example process 200 for providing an advertisement in response to an advertisement request. The example process 200 can, for example, be implemented in the advertisement management system 200 of FIG. 1. The process 200 can also be implemented as instructions stored on a non-transitory computer readable medium, where execution of the instructions cause a data processing apparatus to perform operations of the process 200.

A request for an advertisement for presentation with a first resource is received (202). For example, a user may navigate to a web page using a user device 106. The web page may include one or more advertising slots, each having embedded instructions that initiate a request for an advertisement. In response to executing the instructions of an advertising slot, the user device 106 on which the web page is displayed may submit a request for an advertisement to the advertisement management system 120.

The request may include data regarding the first resource. In some implementations, the request may include data identifying content presented by the resource. For example, if the first resource is a web page, the request may include content from the web page, the URL for the web page, and/or one or more content categories for the web page. Similar data can be included for requests associated with other types of resources. For example, if the first resource is a video, the request may include a title for the video, meta information for the video, one or more content categories for the video, and/or a URL for a web page presenting the video if the video is presented on a web page. In some implementations, the request includes data regarding one or more previously presented resources, as described in more detail below.

In some implementations, the advertisement management system 120, or another system or data processing apparatus, identifies one or more content categories for the first resource. The content categories can be determined based on the content of the first resource. For example, the advertisement management system 120 can determine a topicality score for the first resource with respect to each of a set of content categories. As described above, a topicality score is a value indicative of how relevant a resource is to a particular topic or category. If the topicality score for the first resource and a content category meets a threshold topicality score for the content category, the first resource can be deemed relevant to the content category and/or included in the content category.

In some implementations, the terms for the resource are compared to keywords of the content categories to determine which content categories the resource is associated. To illustrate, a web page that includes several occurrences of the terms “plants,” “flowers,” and “soil” may be assigned to a “gardening” content category, if the gardening content category includes those terms as keywords. Thus, the web page may then be considered to be associated with the gardening content category. The web page may also be assigned to other content categories, such as content categories for plants or flowers.

In some implementations, the user device 106 is configured to identify one or more content categories for the resource and provide the content categories to the advertisement management system 120. For example, the user device 106 may be configured to evaluate the content of the resource in a similar process as the above process. In some implementations, the resource includes data specifying one or more content categories and, upon downloading the resource, the user device 106 identifies the content categories.

Although the first resource may be associated with multiple content categories, for ease of discussion, the remainder of the process 200 is described in terms of the first resource that is associated with a first content category. The process 200 can be modified to handle resources that are associated with multiple content categories as noted in the following description.

A first set of advertisements is identified (204). In some implementations, the advertisement management system 120 identifies, as the first set, advertisements that are eligible to be presented with resources that are associated with the first content category. For example, if the first resource is associated with a gardening content category, the advertisement management system 120 can identify advertisements that are eligible to be presented with resources that are associated with the gardening content category. If the first resource is associated with multiple content categories, advertisements eligible for each of the multiple content categories can be included in the first set. As described above, each advertiser can specify which content categories that its advertisements are eligible for presentation.

A determination is made whether the user device 106 navigated to the first resource from a second resource that is associated with a second content category that is different than the first category (206). This determination can be made in several ways. In some implementations, the user device 106 sends, for example with the request for an advertisement, data indicating that the navigation occurred. For example, the user device 106 may send to the advertisement management system 120 data identifying the second resource and/or the second content category. This data may also specify that the second resource was a last resource presented prior to presentation of the first resource. The advertisement management system 120 can compare the first content category to the second content category to determine whether the content categories are different.

In order to have the data regarding the second resource available to send to the advertisement management system 120 after the user device 106 navigates from the second resource to the first resource, the user device 106 may store the data, for example in a cookie.

In some implementations, the data regarding the second resource is maintained in a web browser by passing the data using an HTTP parameter. In the case of video resource presented on, for example a video player, the data may be maintained in an internal state of the video player.

In some implementations, the advertisement management system 120 logs data regarding content categories for resources that have been presented on the user device 106. For example, when the user device 106 navigates to a resource that includes an advertising slot associated with the advertisement management system 120, the advertisement management system 120 may receive data regarding the content category for the resource.

In particular, each of these slots may initiate a request for an advertisement to the advertisement management system 120, and each request may include data regarding the resource (e.g., a content category of the resource) that includes the advertising slot. The advertisement management system 120 can use the data regarding the resources to identify a content category for each resource, such as the first resource and the second resource, and use that data to determine whether the user device 106 navigated to the first resource from a second resource that is associated with a second content category that is different than the first category. If a previously presented resource is associated with multiple content categories, data regarding each of the content categories can be provided to, or logged by, the advertisement management system 120. In such implementations, data identifying the user may be anonymized.

If it is determined that the user device 106 navigated to the first resource from a second resource that is associated with a second content category that is different than the first category, a second set of advertisements is identified (208). In some implementations, the advertisement management system 120 identifies, as the second set of advertisements, advertisements that are eligible to be presented with resources that are associated with the second content category. In some implementations, the first set of advertisements and the second set of advertisements constitute disjointed sets. For example, if the first content category and the second content category are not relevant to each other, then the advertisements of each set may not be members of the other set.

In some implementations, there may be overlap between advertisements in the first set and the second set. For example, if the first content category is a beach content category and the second content category is a mountain content category, an advertisement for a hotel chain may be a member of both sets.

In some implementations, the second set of advertisements may be limited to advertisements for which their advertiser opted in to allowing the advertisements to be presented on resources that are associated with a different content category than the content categories that have been specified for the advertisements. For example, some advertisers may elect not to purchase advertising space of resources for content categories that may not be relevant to the advertisements. If the advertiser has not opted in, then the advertisements for that advertiser may not be eligible for inclusion in the second set.

An advertisement is selected from among the first and second sets of advertisements (210). In some implementations, the advertisement is selected using an auction process. In some implementations, campaign data 122 and performance data 124 for the advertisements in the first and second sets are used as input parameters to an advertisement auction. For example, the advertisement management system 120 can conduct an auction to select advertisements using the campaign data 122 and the performance data 124 for advertisements included in the first set and advertisements included in the second set.

The advertisements are ranked according to a rank score for each advertisement that, in some implementations, is based on a function of an advertisement bid for the advertisement and one or more parameters or performance measures specified in the performance data 124 (e.g., click through rate, number of impressions, or number of conversions). For example, the rank score for an advertisement can be based on one or more of a click through rate for the advertisement and an advertisement bid for the advertisement. In some implementations, the rank score for an advertisement is proportional to a product of the click through rate and the advertisement bid.

One or more of the highest ranked advertisements (e.g., advertisements having the greatest rank score) resulting from the auction can be selected, irrespective of which set the highest ranked advertisement is included. For example, the highest ranked advertisement may are associated with the second set, the first set, or both sets.

In some implementations, the advertisement system 120 determines whether any of the advertisements that are eligible for inclusion in the second set are not eligible for inclusion in the first set. For example, if the first content category is knitting, while the second content category is football, an advertisement for football apparel may not be eligible for presentation with resources related to knitting. However, if the rank score is higher for the football apparel advertisement than the rank score for advertisements related to knitting, the advertisement management system 120 may select the football apparel advertisement for presentation with the first resource.

If it is determined that the user device 106 did not navigate to the first resource from a second resource that is associated with a second content category that is different than the first category, an advertisement is selected from among the first set of advertisements (212). For example, the first resource may be the first resource that the user device 106 navigates to after the user device 106 is powered on. Or, the first resource and the second resource may have a same or matching content category. For example, the user device 106 may navigate between two web pages of a particular web site (or of two different web sites) and the two web pages may be associated with the same content category or to a same set of content categories. In such cases, the advertisement management system 120 may select an advertisement from only the first set, for example using an auction process.

The selected advertisement is provided to the user device 106 (214). For example, the advertisement management system 120 may transmit the selected advertisement, or data specifying a location of the selected advertisement, to the user device 106. In turn, the user device 106 can present the advertisement with the resource.

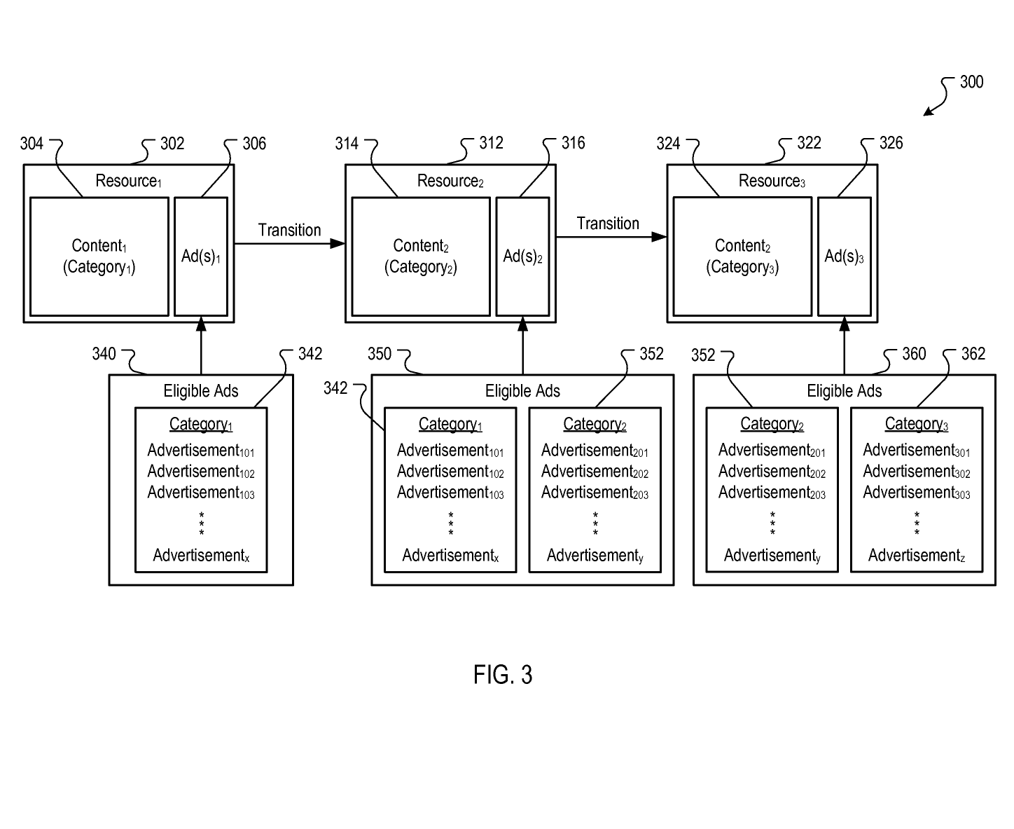

FIG. 3 is a block diagram illustrating a sequence 300 of resources presented by a user device 106 and advertisements eligible for the resources. In particular, a first resource 302 includes content 304 that is associated with a first content category and an advertising slot 306 for presenting one or more advertisements. In this example, no resource has been presented immediately before the first resource 302.

The first resource 302 includes instructions that cause the user device 106 to request, from the advertisement management system 120, one or more advertisements for presentation in the advertising slot 306. In response to receiving the request, the advertisement management system 120 identifies a set of advertisements 340 that are eligible for presentation with the resource 302. This set of advertisements 340 include a set of advertisements 342 that are eligible for presentation with resources that are associated with the first content category, for example, based on content categories that have been selected or otherwise specified by the advertiser. The advertisement management system 120 can select one or more of the advertisements in the set 340 and provide the selected advertisement(s) to the user device 106 for presentation in the advertising slot 306.

After presenting the first resource 302, the user device 106 navigates to a second resource 312, for example in response to a user command. The second resource 312 includes content 314 that is associated with a second content category that is different than the first content category and an advertising slot 316 for presenting one or more advertisements.

The second resource 312 includes instructions that cause the user device 106 to request, from the advertisement management system 120, one or more advertisements for presentation in the advertising slot 316. In response to receiving the request, the advertisement management system 120 identifies a set of advertisements 350 that are eligible for presentation with the resource 312. The set of advertisements 350 includes a set of advertisements 352 that are eligible for presentation with resources that are associated with the second content category, for example, based on the second content category being selected or otherwise specified by the advertiser. As the user device 106 navigated from a resource that is associated with a different content category (i.e., the first content category), the set of advertisements 350 also includes a set of advertisements 342 that are eligible for presentation with resources that are associated with the first content category. As described above, this set 342 may be limited, or filtered, to include only advertisements for which the advertiser opted into presenting the advertisements with resources of different content categories. The set 342 can also be limited, or filtered, to include only advertisements that are not included in the set 352. The advertisement management system 120 can select one or more of the advertisements in the set 350 and provide the selected advertisement(s) to the user device 106 for presentation in the advertising slot 316.

After presenting the second resource 312, the user device 106 navigates to a third resource 322, for example in response to a user command. The third resource 322 includes content 324 that is associated with a third content category that is different than the second content category and an advertising slot 326 for presenting one or more advertisements.

The third resource 322 includes instructions that cause the user device 106 to request, from the advertisement management system 120, one or more advertisements for presentation in the advertising slot 326. In response to receiving the request, the advertisement management system 120 identifies a set of advertisements 360 that are eligible for presentation with the resource 322. The set of advertisements 360 includes a set of advertisements 362 that are eligible for presentation with resources that are associated with the third content category. As the user device 106 navigated from a resource that is associated with a different content category (i.e., the second content category), the set of advertisements 360 also includes a set of advertisements 352 that are eligible for presentation with resources that are associated with the second content category. As described above, this set 352 may be limited, or filtered, to include only advertisements for which the advertiser opted into presenting the advertisements with resources of different content categories. The set 352 can also be limited, or filtered, to include only advertisements that are not included in the set 362.

Although in this example, the set of advertisements 360 includes the sets advertisements 352 and 362 that are eligible for presentation with resources that are associated with the second and third content categories, in some implementations the set of advertisements 360 may also include the set of advertisements 342 that are eligible for resources that are associated with the first content category. In some implementations, the advertisement management system 120 allows the advertiser to select a maximum number of resources that can be presented between a resource that is associated with a content category for which the advertisement is eligible and the current resource, and the advertisement remain eligible. For example, the advertiser may specify that the advertisement is only eligible for presentation on the next resource after a resource that is associated with a content category for the advertisement is presented.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving, from a user device, a request for a content item for presentation with a first resource, the first resource being associated with one or more content categories including a first content category;
identifying a first set of content items that are eligible for presentation with resources associated with the first content category;
determining that the user device navigated, directly or indirectly, to the first resource from a second resource, the second resource being associated with one or more content categories including a second content category, the second content category being different than the first content category;
identifying, in response to determining that the user device navigated to the first resource from the second resource, a second set of content items that are eligible for presentation with resources associated with the second content category, the second set of content items including a disjoint set relative to the first set of content items;
selecting, from among the first set of content items and the second set of content items, a content item for presentation with the first resource; and
providing, to the user device, the selected content item for presentation with the first resource.

2. The method of claim 1, wherein selecting a content item for presentation with the first resource comprises selecting a content item from the second set of content items.

3. The method of claim 2, wherein selecting the content item from the second set of content items comprises:
determining that a particular content item in the second set of content items has a highest rank score of content items that are included in the first set of content items and the second set of content items, the rank score for each content item being based on at least one of a bid amount for the content item and a performance measure for the content item; and
selecting the particular content item from the second set of content items.

4. The method of claim 1, wherein the second resource is a last resource that was presented on the user device prior to presentation of the first resource.

5. The method of claim 1, wherein the selected advertisement is selected irrespective of the first content category.

6. The method of claim 1, further comprising:
determining that a particular content item in the second set of content items is not eligible for inclusion in the first set of content items, wherein:
selecting a content item comprises selecting the particular content item for presentation with the first resource.

7. The method of claim 1, wherein the first resource is one of a web page, a video, a game, an image, or a map.

8. A non-transitory computer storage medium encoded with a computer program, the program comprising instructions that when executed by data processing apparatus cause the data processing apparatus to perform operations comprising:
receiving, from a user device, a request for a content item for presentation with a first resource, the first resource being associated with one or more content categories including a first content category;
identifying a first set of content items that are eligible for presentation with resources associated with the first content category;
determining that the user device navigated, directly or indirectly, to the first resource from a second resource, the second resource being associated with one or more content categories including a second content category, the second content category being different than the first content category;
identifying, in response to determining that the user device navigated to the first resource from the second resource, a second set of content items that are eligible for presentation with resources associated with the second content category, the second set of content items including a disjoint set relative to the first set of content items;
selecting, from among the first set of content items and the second set of content items, a content item for presentation with the first resource; and
providing, to the user device, the selected content item for presentation with the first resource.

9. The computer storage medium of claim 8, wherein selecting a content item for presentation with the first resource comprises selecting a content item from the second set of content items.

10. The computer storage medium of claim 9, wherein selecting the content item from the second set of content items comprises:
determining that a particular content item in the second set of content items has a highest rank score of content items that are included in the first set of content items and the second set of content items, the rank score for each content item being based on at least one of a bid amount for the content item and a performance measure for the content item; and
selecting the particular content item from the second set of content items.

11. The computer storage medium of claim 8, wherein the second resource is a last resource that was presented on the user device prior to presentation of the first resource.

12. The computer storage medium of claim 8, wherein the selected advertisement is selected irrespective of the first content category.

13. The computer storage medium of claim 8, wherein the program includes instructions that when executed by the data processing apparatus cause the data processing apparatus to perform operations further comprising:
determining that a particular content item in the second set of content items is not eligible for inclusion in the first set of content items, wherein:
selecting a content item comprises selecting the particular content item for presentation with the first resource.

14. A system, comprising:
a data store for storing content items; and
one or more processors configured to interact with the data store, the one or more processors being further configured to perform operations comprising:
receiving, from a user device, a request for a content item for presentation with a first resource, the first resource being associated with one or more content categories including a first content category;
identifying a first set of content items that are eligible for presentation with resources associated with the first content category;
determining that the user device navigated, directly or indirectly, to the first resource from a second resource, the second resource being associated with one or more content categories including a second content category, the second content category being different than the first content category;
identifying, in response to determining that the user device navigated to the first resource from the second resource, a second set of content items that are eligible for presentation with resources associated with the second content category, the second set of content items including a disjoint set relative to the first set of content items;
selecting, from among the first set of content items and the second set of content items, a content item for presentation with the first resource; and
providing, to the user device, the selected content item for presentation with the first resource.

15. The system of claim 14, wherein selecting a content item for presentation with the first resource comprises selecting a content item from the second set of content items.

16. The system of claim 15, wherein selecting the content item from the second set of content items comprises:
determining that a particular content item in the second set of content items has a highest rank score of content items that are included in the first set of content items and the second set of content items, the rank score for each content item being based on at least one of a bid amount for the content item and a performance measure for the content item; and
selecting the particular content item from the second set of content items.

17. The system of claim 14, wherein the second resource is a last resource that was presented on the user device prior to presentation of the first resource.

18. The system of claim 14, wherein the selected advertisement is selected irrespective of the first content category.

19. The system of claim 14, wherein the one or more processors are further configured to perform operations comprising:
determining that a particular content item in the second set of content items is not eligible for inclusion in the first set of content items, wherein:
selecting a content item comprises selecting the particular content item for presentation with the first resource.

20. The system of claim 14, wherein the first resource is one of a web page, a video, a game, an image, or a map.
